(19) United States
(12) Patent Application Publication
(10) Pub. No.: US 2007/0188453 A1
(43) Pub. Date: Aug. 16, 2007

(54) Input device roller with hybrid magnetic ratchet system

(75) Inventor: Timothy O'Sullivan, Bantry (IE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/355,497

(22) Filed: Feb. 15, 2006

(51) Int. Cl. G09G 5/08

(52) U.S. Cl. 345/163

(57) ABSTRACT

A rotatable wheel for an input device which interfaces with a computer. The input device includes both a permanent magnet and an electromagnet. A rotor of material which will magnetically interact with the permanent magnet and electromagnet is coupled to the rotatable wheel. The permanent magnet and electromagnet can be used to control a ratchet force applied to the rotatable wheel. In an alternate embodiment, a rotatable wheel with a flywheel is engaged with a roller. A ratchet wheel can be intermittently engaged with the flywheel to provide a ratchet force. By disengaging the ratchet wheel, the flywheel can be allowed to spin, providing momentum to allow for easier scrolling in certain conditions, such as for scrolling through a long document.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates to a roller or wheel on an input device, such as a mouse. In particular, it relates to providing a magnetic ratchet or detent force for the user of the roller.

A roller is typically used on a mouse in addition to the primary input which comes from moving the mouse around on a ball protruding from the bottom of the mouse housing. Alternately, an optical sensor may be used instead of a ball. Other input devices, such as a track ball with the ball on top, a joystick, etc., will have a movable portion for providing the input. In addition to this movable portion, a roller may be added as well. The roller can be used for such functions as scrolling or zooming. The roller is operated by a user's finger, much like a dial on a radio.

There are a number of different designs for such rollers on a mouse or other device. Examples include Multipoint Technology Corporation U.S. Pat. No. 5,298,919, Microsoft U.S. Pat. No. 5,473,344, Apple Computer U.S. Pat. Nos. 5,313,230 and 5,095,303, Mouse Systems U.S. Pat. Nos. 5,530,455 and 5,446,481, Primax Electronics U.S. Pat. No. 5,808,568, and Logitech U.S. Pat. No. 6,157,369.

Force feedback has been used in different input devices, including mice. Examples of force feedback mechanisms can be found in a number of patents assigned to Immersion Corporation, such as U.S. Pat. No. 5,825,303, U.S. Pat. No. 5,734,373, U.S. Pat. No. 5,767,839, U.S. Pat. No. 5,721,566, U.S. Pat. No. 5,805,140, U.S. Pat. No. 5,691,898 and U.S. Pat. No. 5,828,197.

Immersion Corporation U.S. Pat. No. 6,128,006 describes force feedback on a mouse wheel (roller). The mechanism shown is a motor either directly connected to the axle of the mouse wheel, or a pulley drive coupled to the axle. A passive actuator such as a magnetic particle brake or a friction brake is discussed.

U.S. Pat. No. 6,128,006 also describes a number of different types of feedback. The feedback can be provided to simulate the ratchet effect currently provided by mechanical spring-type mechanisms in mouse wheels. The feedback can also be used to provide user feedback when a line is crossed on a document on a display. Similar feedback can be provided for the end of the page or the end of a document. The patent also describes providing an amount of feedback which is related to the size of the document. The patent also describes that when the wheel is used for a cursor, feedback can be provided on graphic items that the cursor passes over. In addition, a roller can vibrate to indicate an alert, such as an email message or an error in a program.

Culver (Immersion) U.S. Pat. No. 6,300,938 describes an electromagnetic brake that can be used on a cylindrical roller. This can be used for various force feedback effects, including detents. Logitech U.S. Pat. No. 6,809,727 describes various uses of magnets, solenoids and electromagnets for force feedback in a roller for various effects, including a detent or ratcheting effect. In particular an electromagnetic brake is described.

The use of magnets or magnetism for detecting x-y movement, such as by using a magnetic ball in a mouse, is shown in U.S. Pat. No. 5,583,541, U.S. Pat. No. 5,696,537 and U.S. Pat. No. 6,809,722. Other patents mentioning magnetic sensors for input devices include U.S. Pat. No. 6,624,808, U.S. Pat. No. 6,483,294 and Logitech U.S. Pat. No. 6,400,356.

A disadvantage of force feedback is the power required to provide the force which is felt by the user. This is particularly problematic for a cordless mouse or other device which relies on batteries, or on a device which is powered off of the limited power from the universal serial bus (USB)

### BRIEF SUMMARY OF THE INVENTION

The present invention provides a rotatable wheel for an input device which interfaces with a computer. The input device includes both a permanent magnet and an electromagnet. A rotor of material which will magnetically interact with the permanent magnet and electromagnet is coupled to the rotatable wheel. The permanent magnet and electromagnet can be used to control a ratchet force applied to the rotatable wheel.

The ratchet force can be strengthened by energizing the electromagnet so that its magnet field combines with that of the permanent magnet. Alternately, the electromagnet can be energized in the opposite direction to cancel the magnetic filed in the permanent magnet. This can be used to remove the ratchet force, which may be desirable in certain situations, such as for scrolling long documents.

The present invention also provides, in one embodiment, a rotatable wheel with a flywheel which is engaged with a rotatable wheel. A ratchet wheel can be intermittently engaged with the flywheel to provide a ratchet force. By disengaging the ratchet wheel, the flywheel can be allowed to spin, providing momentum to allow for easier scrolling in certain conditions, such as for scrolling through a long document.

The ratchet wheel may be oval-shaped in one embodiment, such that, as it rotates, its diameter changes as it passes through the long parts of the oval. This provides greater force against the scroll wheel and then a weaker force to provide a ratchet effect. The oval-shaped ratchet wheel is biased against the flywheel with spring. The strength of the spring can be adjusted, such as by using a screw. In addition, a solenoid can be provided to disengage the ratchet wheel when it is desired to have the flywheel freely moving.

For a further understanding of the nature and advantages of the invention, reference should be made to a following description taken in conjunction with the accompanying drawings.

### BRIEF DESCRIPTION OF THE DRAWINGS

FIG. 1 is a block diagram of the electronics of the tactile feedback according to one embodiment of the present invention.

FIG. 2 is a block diagram of the tactile feedback software according to an embodiment of the invention.

FIG. 3 is a diagram of a combined permanent magnet and electromagnet interacting with a rotor according to an embodiment of the invention.

FIG. 4 is a diagram illustrating the permanent magnet of FIG. 3 and its flux fields.

FIG. 5 is a diagram illustrating a combined flux field of the permanent and electromagnets.

FIG. 6 is a diagram illustrating the electromagnetic flux field canceling the permanent magnet flux field.

FIG. 7 is a diagram illustrating the direction of the magnetic fields of different points to produce the canceling effect.

FIG. 8 is a diagram of a simulation showing a Halbach array for canceling a magnetic field on one side and magnifying it on the other.

FIG. 9 is a diagram illustrating the permanent electromagnets of the invention interacting with a iron ratchet wheel connected by planetary gears to a scroll wheel.

FIG. 10 is a diagram of the embodiment of FIG. 9 showing the addition of a lead screw for controlling the permanent magnet distance to the ratchet wheel.

FIG. 11 is a diagram of a flywheel and ratchet wheel embodiment for controlling a scroll wheel ratchet.

FIG. 12 is a side view of the ratchet wheel and flywheel interaction of FIG. 11.

FIG. 13 is a diagram of the embodiment of FIG. 12 illustrating the long diameter position of the oval ratchet wheel against the flywheel.

FIG. 14 is a diagram of a side view illustrating the oval ratchet wheel being retracted by a solenoid.

FIG. 15 is a diagram of an embodiment of a metal ratchet wheel attached to an axle with an electromagnet.

FIG. 16 is a diagram of a electro-permanent magnet.

FIG. 17 is a diagram of an embodiment with a keeper in place to restrain the magnetic flux and avoid force on the wheel.—18 uses magnetic flux path adjustment.

FIG. 18 is a diagram of the embodiment of FIG. 17 with the keeper having been moved to allow magnetic flux to apply force to the wheel.

FIG. 19 is a simplified diagram of a DC motor 200 may be coupled to a roller wheel or may form a portion of a roller wheel of the control device.

### DETAILED DESCRIPTION OF THE INVENTION

### System Overview

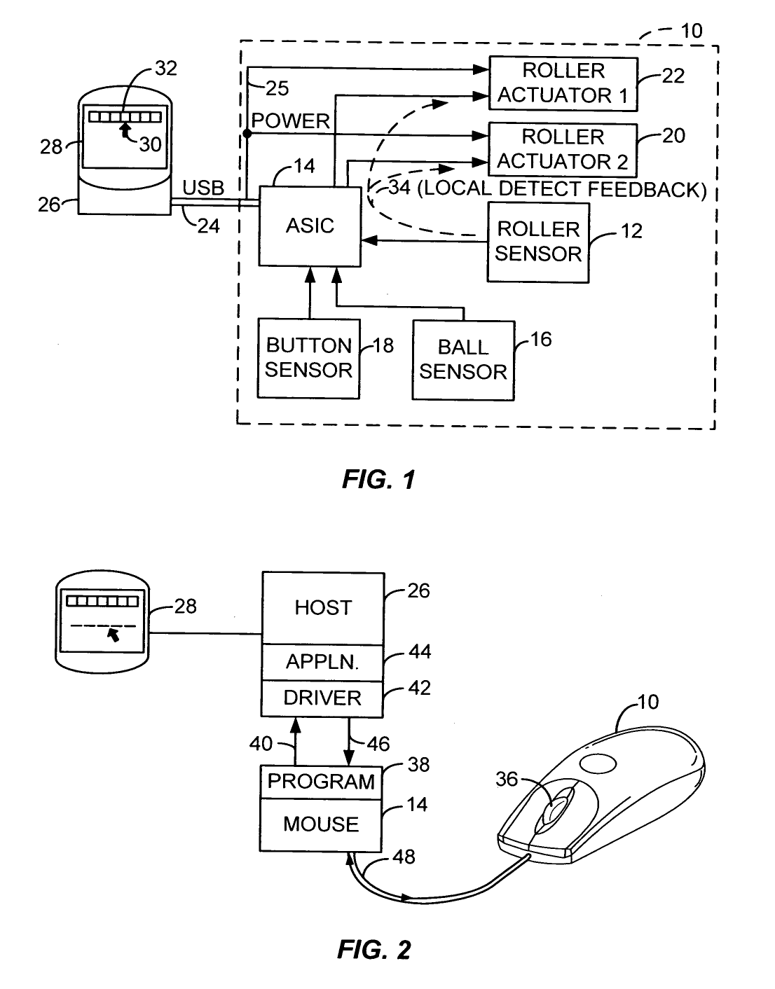

FIG. 1 is a block diagram of the electronic system for tactile feedback according to an embodiment of the invention. Shown is a mouse 10 which has a roller sensor 12 for detecting the movement of a roller or wheel. The sensor signals are provided to a processing circuit in an ASIC 14. ASIC 14 also receives signals from a mouse sensor 16 and button sensors 18. Mouse sensor 16 provides detector signals from two encoder rollers on a mouse ball, or alternately an optical signal on an optical mouse.

ASIC 14 also controls two roller actuators 20 and 22 which provide a ratcheting function on the mouse roller or wheel, as will be described below. The actuators which need power receive their power on lines 25 from a USB 24. Thus, the amount of power used by the actuators needs to be minimized. The sensor signals received by ASIC 14 are put into a packet format and transmitted over USB 24 to a host computer 26 for controlling a display 28. Host 26 may provide feedback signals back to ASIC 14 in response to the position of a cursor 30 on display 20, such as having less ratchets in a long document.

In one mode, instead of a sensor signal being sent to the host, and feedback signals being received back, the host can be bypassed to provide a detent feel to rotation of the mouse roller. In prior rollers, this has been done mechanically through the use of a spring mechanism mounted in the mouse. In the present invention, this can be provided through the tactile feedback mechanism using the detent local feedback path indicated by the dotted line 34 in FIG. 1. The timing of detents or ratchets can be controlled by turning off the magnetic system periodically. A roller sensor signal from roller sensor 12 indicates that the roller has been turned a predetermined amount, a signal can be provided to the appropriate roller actuator of roller actuators 20 and 22. The use of such local feedback eliminates the need to send data over the USB or over a wireless link, removing bandwidth concerns and also providing more instantaneous feedback.

FIG. 2 is a block diagram of the software used in an embodiment of the present invention. Shown is a mouse 10 with a roller 36. Inside mouse 10 is a processor or ASIC 14 including a program 38 for controlling the mouse. Sensor signals 40 are provided to host computer 26, in particular to a driver 42 in the host. The driver in turn can provide signals to an application program 44, which controls the particular graphics on a display 28. Upon certain conditions, such as scrolling up a line or page, a tactile feedback signal can be provided from application program 44 to driver 42 and back to ASIC 14 as control commands 46. In response to these, program 38 provides signals 48 to the stepping motor in mouse 10.

### Combined Permanent and Electromagnets

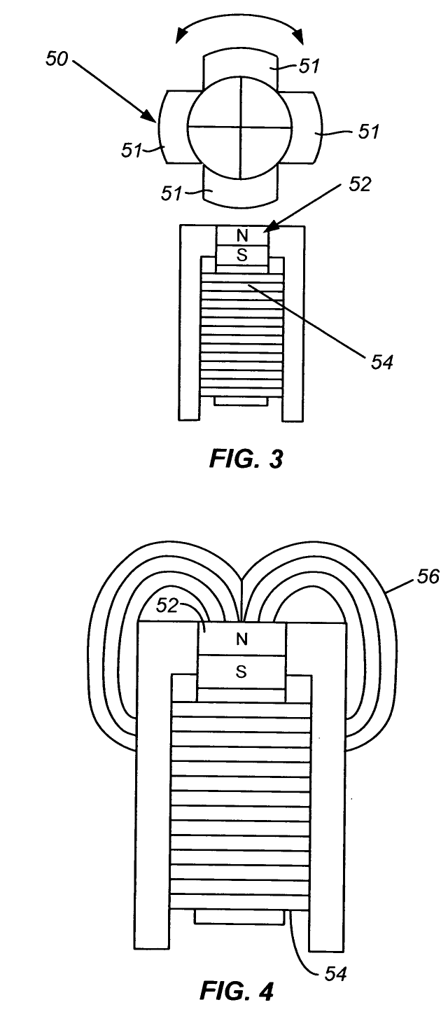

FIG. 3 illustrates a rotor 50 made of iron. Rotor 50 can be coupled to a wheel (roller) via an axle or other device. FIG. 3 shows a permanent magnet 52, preferably made of Neodymium (NdFeB). The permanent magnet 52 interacts with the rotor, as it rotates, to provide varying amounts of magnetic attraction, thus simulating the feel of a mechanical ratchet. A neutralizing electromagnet 54 is mounted adjacent the permanent magnet 52.

As shown in FIG. 4, the flux lines 56 of the permanent magnet only provides sufficient force to give the ratcheting function. This is done by attracting the fingers 51 of the rotor as it rotates. This requires no power, and provides a reliable and smooth ratcheting action without sound or wear.

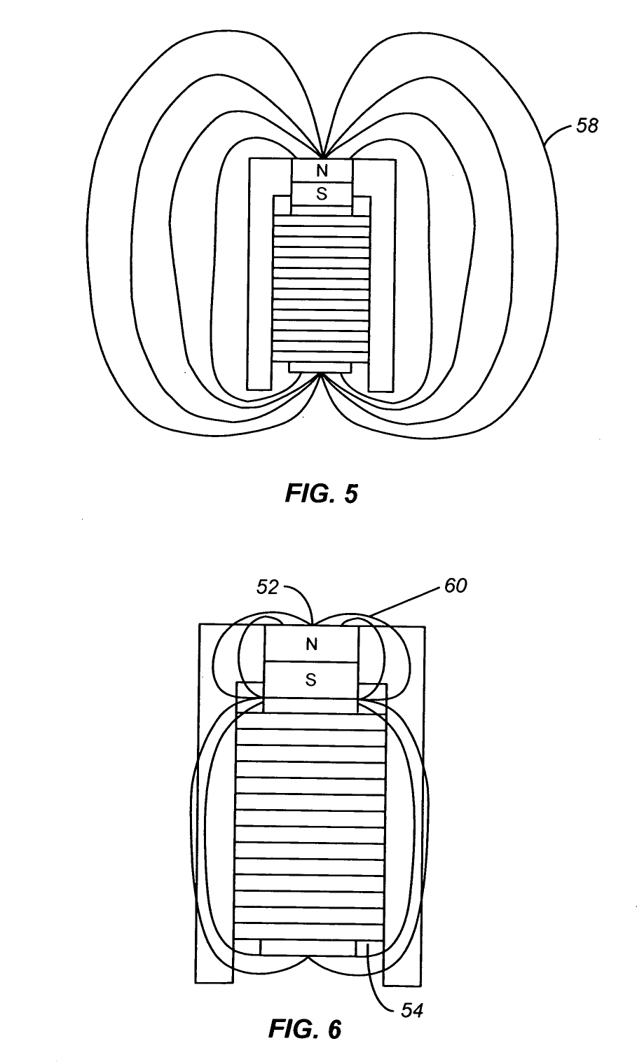

FIG. 5 illustrates a combined flux field 58 from both the permanent magnet 52 and the electromagnet 54. The electromagnet can be activated to provide this reinforced flux field in certain circumstances. For example, if a braking action is to be performed, the electromagnet can be energized in the same polarity as the Neodymium permanent magnet. Two fields then complement and reinforce each other, leading to a much larger compound field which restricts the rotation of the iron rotor 50 and locks the rotation of the scroll wheel.

FIG. 6 illustrates greatly reduced combined opposing flux fields 60 generated by the permanent magnet 52 and electromagnet 54. The electromagnet can be energized in the opposite polarity of the permanent magnet when it is desired to disengage the ratchet. The result is a distorted combined field of greatly reduced size and intensity. Thus, iron rotor 50 is minimally influenced by the magnetic field and can freely spin, allowing the scroll wheel to freely spin using its own inertia. This can be activated when desired, such as for long documents where the ratchet effect is not desired.

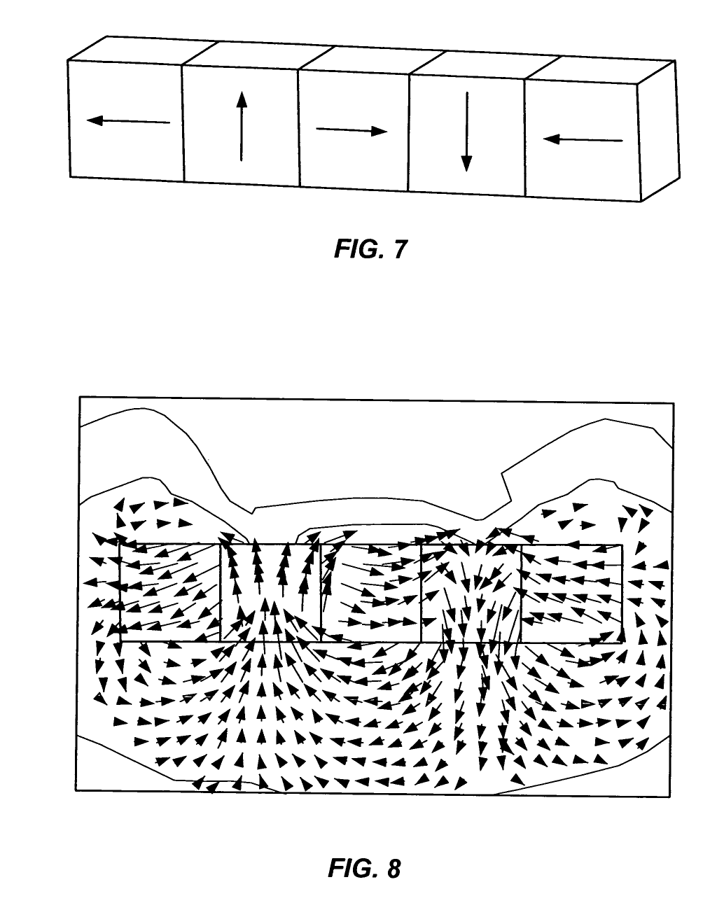

This principle of magnetic fields is scientifically sound and a well established technology and is the principle behind the Halbach array. FIG. 7 illustrates the directions of the different flux lines in a Halbach array. FIG. 8 is a diagram showing a simulation of the flux directions of FIG. 7 illustrating the entire flux lines. This shows that a Halbach array can cancel a field on one side and magnify it on the other. This is the principle used in the hybrid ratchet of this embodiment of the present invention.

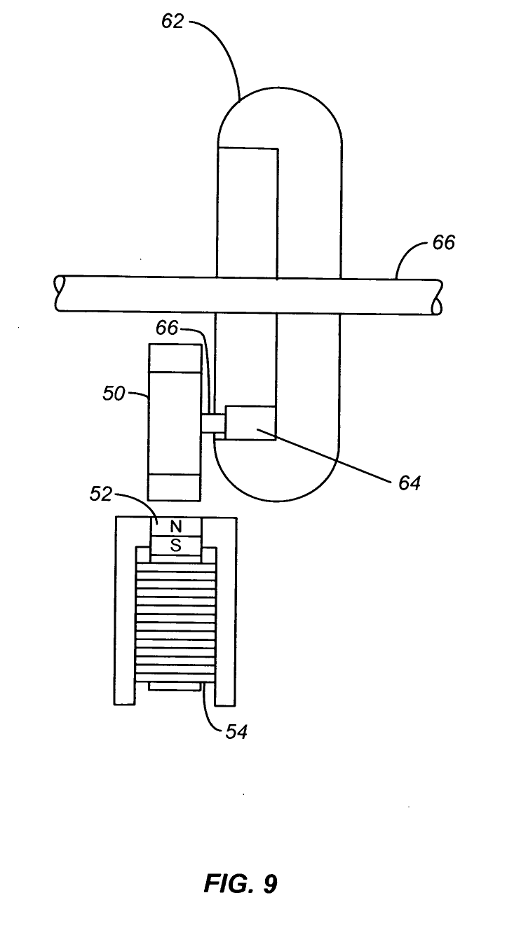

FIG. 9 illustrates the magnets and rotor interacting with a main scroll wheel 62. This interaction is done through planetary gears 64. Scroll wheel 62 rotates about an axle 66, while planetary gears 64 engage, through an axle 66, with the iron rotor 50. As discussed earlier, rotor 50 interacts with permanent magnet 52 and electromagnet 54 to provide the desired ratchet force when desired. As noted above, by partially energizing the electromagnet, the ratcheting force may be temporarily increased or decreased as the need arises. By using the electromagnet only for the unusual situations where the ratchet force needs to be increased (for a break) or eliminated (for non-ratchet scrolling), the use of power for energizing the electromagnet is minimized. In addition, the iron rotor or ratchet wheel has the benefit that it can act as a flywheel, storing momentum to allow the main scroll wheel to keep rotating as it cruises through long documents.

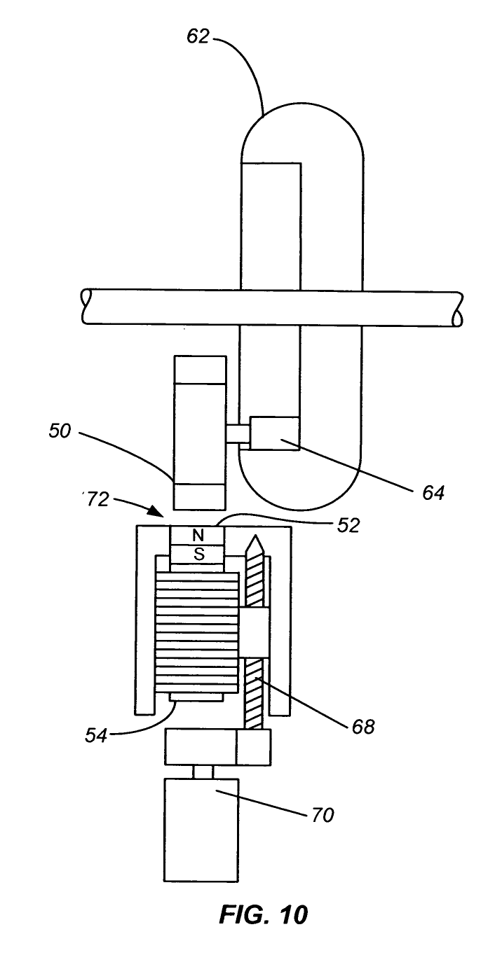

FIG. 10 illustrates the embodiment of FIG. 9 with the addition of lead screw 68 controlled by a DC motor 70. The DC motor can advance or retard the lead screw to increase or decrease the magnetic field by controlling the gap 72 between the permanent and electromagnets and the iron rotor. Alternately, a user could manually adjust the distance and thus adjust the ratchet force by means of a screw accessed from the bottom of the input device, such as a mouse.

### Flywheel Embodiment

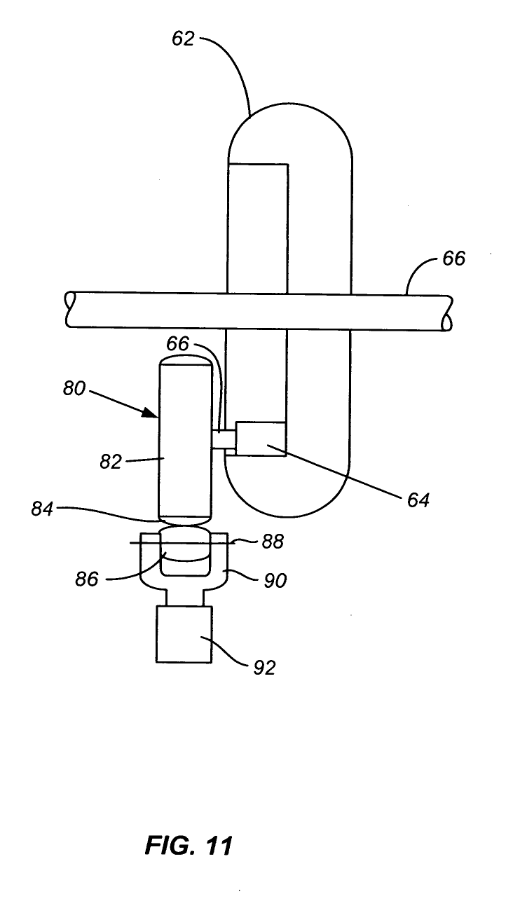

FIG. 11 illustrates an embodiment of the invention using a flywheel 80 connected via an axle 66 to planetary gears 64 in a scroll wheel 62 rotating about an axle 66. The flywheel preferably has a brass or other metal or heavy material interior 82, with a rubber or other soft material for a tire surface 84 around its circumference. The tire surface engages with an oval ratchet wheel 86 mounted on an axle 88 in support arms 90. The engagement of oval ratchet wheel 86 with the flywheel 80 is controlled by a solenoid—spring assembly 92. The rubber tire reduces noise and allows smooth engagement with the oval ratchet wheel. The oval ratchet wheel can be disengaged, to allow the flywheel to spin freely. The planetary gear arrangement allows the flywheel to spin much faster than the main wheel, allowing build up of momentum.

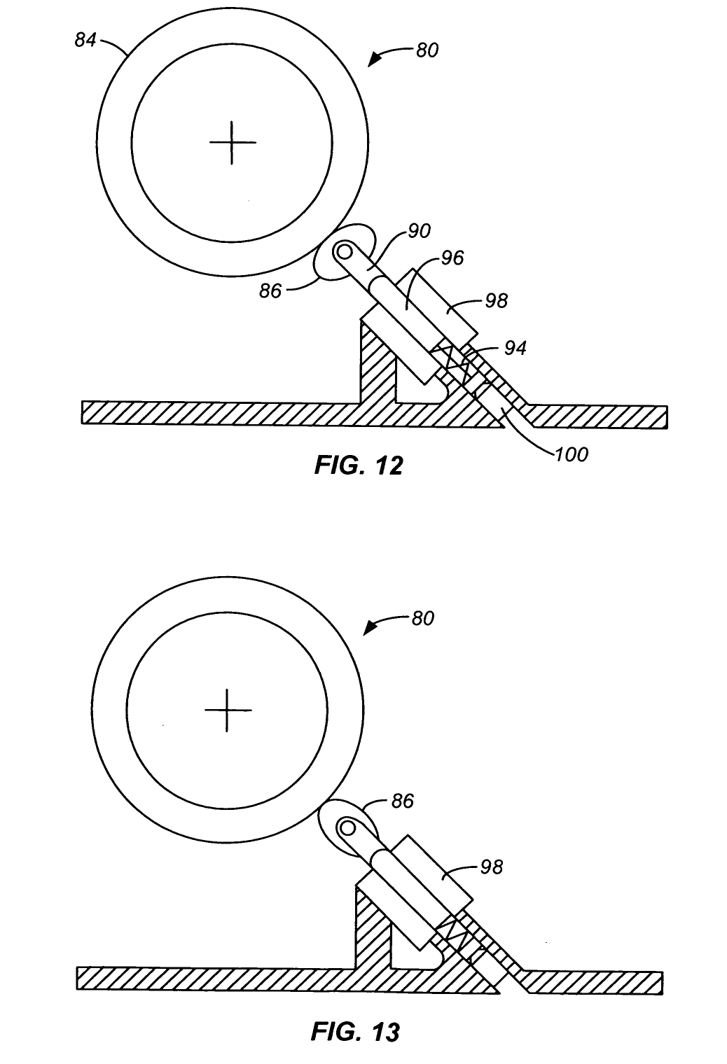

FIG. 12 is a side view of the flywheel 80 and oval ratchet wheel 86. A spring 94 provides a biasing force to an iron core rod 96 which supports arms 90 and oval ratchet wheel 86. A solenoid 98 interacts with the iron core 96 to advance or retard it as desired to engage or disengage the ratchet wheel. The biasing force of spring 94 can be controlled by grub screw 100. As the main rubber tire 84 rotates, the oval wheel rotates as well, causing the iron core plunger 96 of the solenoid to move in and out, compressing the spring and creating a ratchet effect.

FIG. 13 illustrates the embodiment of FIG. 12 when the oval wheel has rotated 90 degrees to its maximum position which provides the maximum force against flywheel 80. Alternately to using a grub screw which can be tightened or loosened by a user, there could be a dial at the bottom of the input device (e.g. mouse, keyboard, etc.), to allow adjustment without the need for any tools.

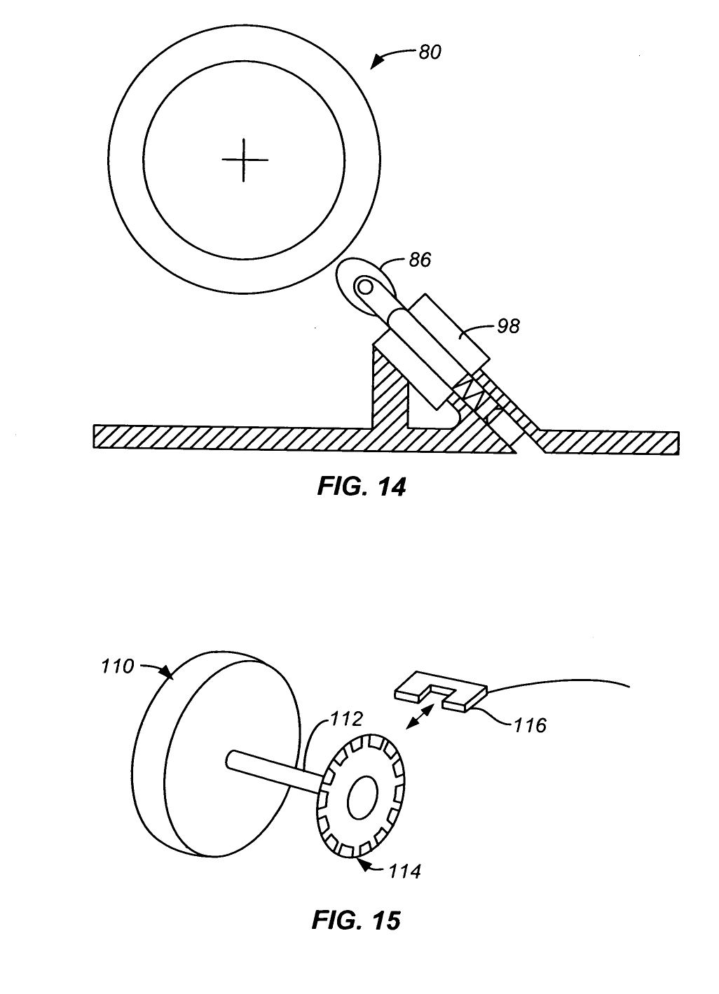

FIG. 14 illustrates the embodiment of FIG. 12 with the solenoid activated to retract the oval ratchet wheel 86. This allows flywheel 80 to spin freely, without a ratchet effect. This can be activated, for example, when a person enters a long document and rapidly flicks the main scroll wheel. This angular acceleration can be detected by the scroll wheel encoder, and a solenoid can be energized in response to retract the ratchet wheel. The inertia of the flywheel will allow the main wheel to spin for quite some time, thus allowing the user to cruise through a long document without constantly moving the scroll wheel with the user's finger. It is also possible to partially reduce the ratchet force electronically by partially energizing the solenoid to counteract the spring.

FIG. 15 is a diagram of a roller wheel 110 with an axle 112 attached to a pressed metal disk 114. The disk interacts with an electromagnet 116 to produce the ratchet effect. The disk can have teeth to create the ratchet effect. Alternately, the disk can be smooth, with the turning on and off of the electromagnet producing the ratchet effect. The electromagnet can be pulsed according to the sensed rotation of the roller. The amount of force can be varied by varying the current provided to the electromagnet. In an alternate embodiment, the metal disk can be mounted inside the roller, with the electromagnet adjacent a point on the roller, or having a U-shape extending around the sides of the roller.

### Electro-Permanent Magnet Technology

An alternative embodiment to the hybrid magnetic system is the use of electro-permanent magnet systems. These offer a very high tech solid state solution that addresses some of the drawbacks of a hybrid magnetic system. The primary drawback with the hybrid magnet system is that it requires continuous power for free wheeling. This is fine if free wheeling is only carried out occasionally. However if a user wants free wheeling as the default mode then obviously the continuous power consumption becomes an issue.

Electro-permanent technology solves this problem because it only required power to change state. Once in the desired state (such as free wheeling or ratchet mode) no additional power is required. This embodiment replaces the electromagnet and permanent magnet in the previous system with electro-permanent magnets. Electro-permanent magnets have a permanent magnet and an electromagnet with one key difference from the hybrid embodiment. The permanent magnet is made from a material which is relatively easily re-magnetized, such as Alnico, unlike the NdFeB used in the previous system.

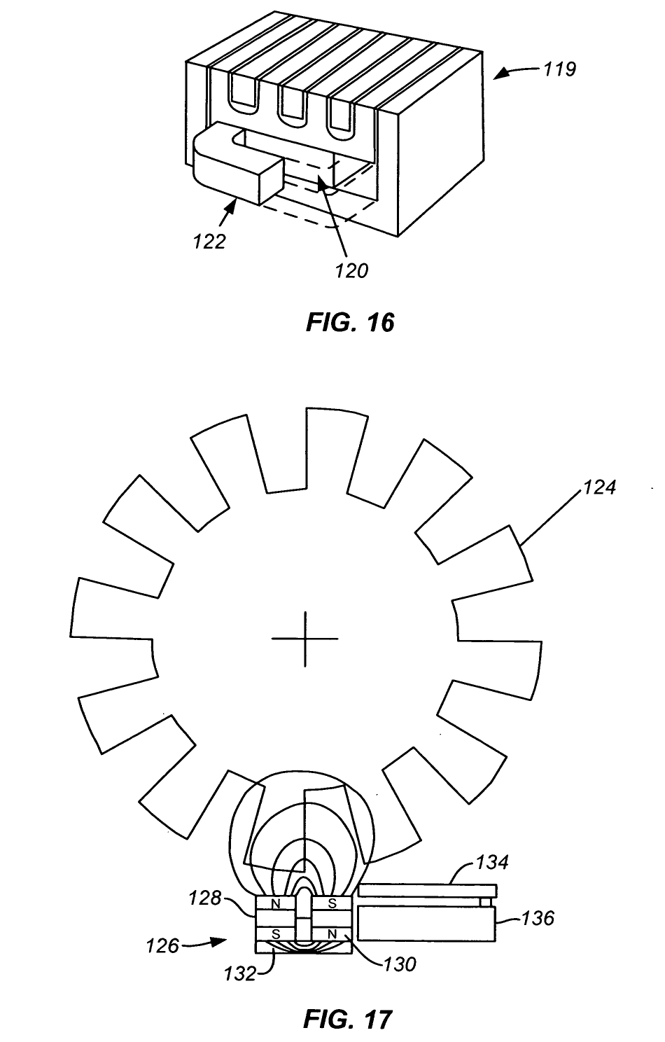

FIG. 16 is a diagram of a electro-permanent magnet 119. It is composed of a permanent magnet 120 surrounded by electrical coils 122. This can be substituted for the magnet system of permanent magnet 52 and electromagnet 54 of FIG. 9

When current flows in a wire coil around the electro-permanent material, the electromagnetic field causes the electro-permanent material to align in the same orientation, creating a large magnetic field which is a combination of the two. After the current in the coil is halted, the electro-permanent material retains its magnetic orientation, the remaining field is slightly smaller than the previous (with the electromagnetic contribution) but still significant and should last indefinitely. To eliminate the magnetic field, the electro-permanent material is returned to a random magnetic orientation, with no noticeable magnetic field, by passing a brief scrambling AC current through the wire coils.

To turn the system on, (engage the ratchet) a brief pulse of current is passed through the coils of the electromagnet, this creates a powerful but short lived magnetic field which magnetizes the electro-permanent magnet material. When the current is switched off after a fraction of a second, the electromagnet no longer creates a magnetic field, however the permanent magnet retains its magnetism. This permanent magnetic field can be used to create the ratcheting or braking effect.

To turn the ratchet off for free wheeling, a current is passed through the electromagnet in the opposite direction. This creates a brief magnetic field which neutralizes the permanent magnet, there by switching the permanent magnet off. By controlling the duration of the current pulse in the electromagnet, it is possible to alter the strength and polarity of the permanent magnet or to demagnetize it completely.

This embodiment provides an adjustable ratchet force and braking mechanism that is silent, solid state, with no wear and with power required only for changing state.

### Keeper or Flux Path Modification

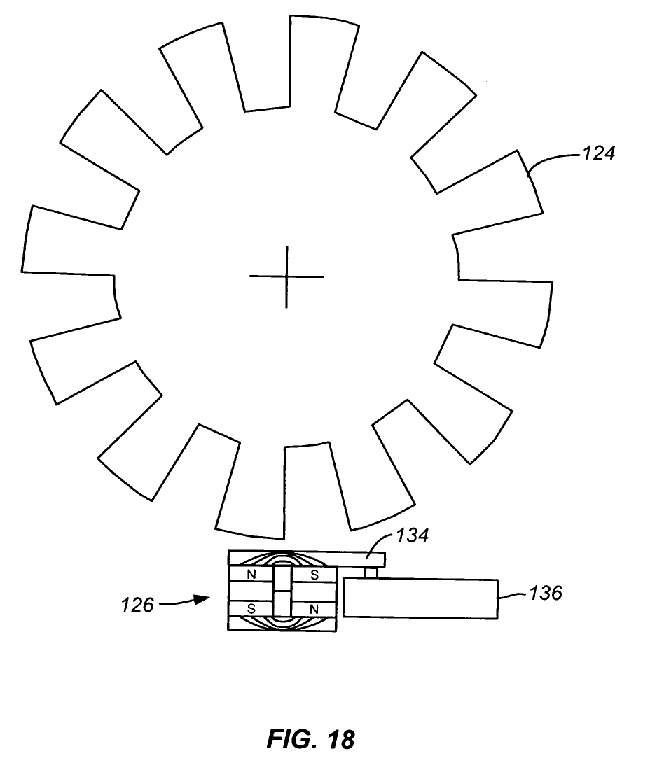

The embodiment of FIGS. 17-18 uses magnetic flux path adjustment. FIGS. 17-18 show a punched iron wheel 124 could be placed in the scroll wheel itself, or as an iron ratchet wheel as shown by wheel 50 in FIG. 9. A permanent magnet 126 has two poles 128 and 130 joined at the bottom by a fixed keeper 132. The keeper is an iron or other bar for constraining the magnetic flux and minimizing the amount escaping. The top of the magnet is open in FIG. 17, with magnetic flux lines interacting with the iron teeth of wheel 124. A movable keeper 134 is maintained away from the flux lines by an actuator 136.

FIG. 18 shows keeper 134 having been moved by actuator 136 into the path of the flux lines to constrain the flux, and avoid interaction with the teeth of wheel 124. The keeper can be moved into and out of position by actuator 136 as the scroll wheel is turned, giving a ratchet feedback effect. In addition, it can produce a braking effect. The amount of braking can be controlled by whether the keeper is moved completely or only partially into position, giving a variance in how much of the magnetic flux is constrained. For a free wheeling mode, the keeper is maintained over the magnet to constrain the magnetic flux.

This embodiment has the advantages of a magnetic ratchet, but power is only needed to change mode, It does require moving parts (keeper/actuator) as opposed to being solid state, and a large force is required to move the keeper.

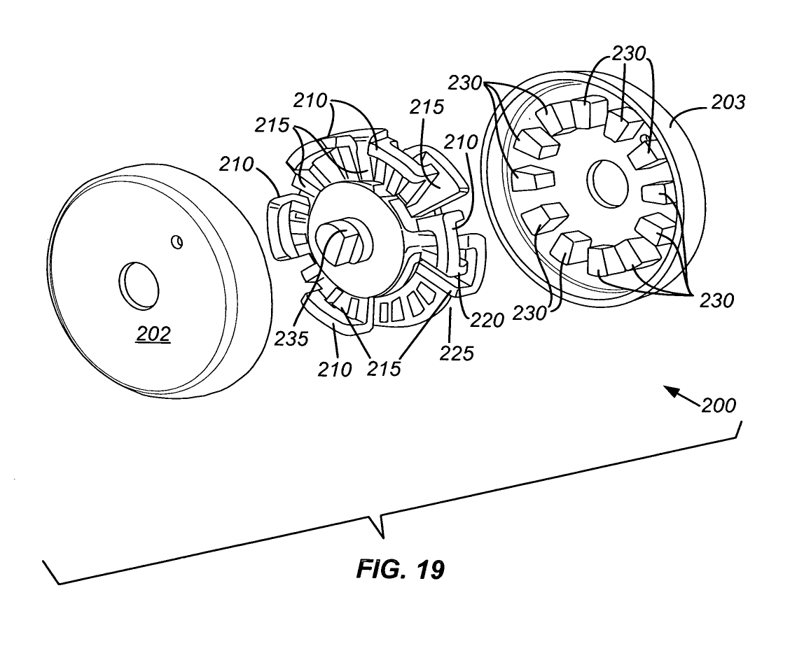

FIG. 19 is a simplified diagram of a DC motor 200 that may be coupled to a roller wheel (e.g., via a gear system, an axel, etc.) or may form a portion of a roller wheel of the control device. The DC motor includes first and second housings 202 and 203, first and second coils 210 and 215, and a set of sensors 220 coupled to a printed circuit board (PCB) 225. The second housing includes a set of magnets 230 and adjacent magnets have poles that face in substantially opposite directions. The housings and the magnets may be coupled to a portion of the roller wheel that a user pushes on to rotate the roller wheel such that the housings and magnets rotate with the roller wheel. In this embodiment, the housings and the magnets may be configured to rotate relative to the coils and/or the sensors. Alternatively, the coils and/or the sensors may be coupled to the roller wheel (e.g., via an axel 235) and may be configured to rotate with respect to the roller wheel while the housings and the magnets are substantially fixed.

According to one embodiment, as the roller wheel is rotated, current may be directed through one or both of the coils to effect magnetic interactions between the coils and the magnets to provide a ratchet force for the roller wheel. The magnitude of the ratchet force may be increased or decreased based on the amount of current driven through one or both of the coils. Alternatively, no current may be driven through the coils such that roller wheel rotates substantially smoothly in a smooth-roller mode, i.e., without ratcheting.

According to one embodiment, current may be driven through one or both of the coils such that the one or both of the coils magnetically interact with the magnets to rotate the housing and thereby rotate the roller wheel. Such a self propelled roller wheel mode may be initiated for scrolling through relatively long documents or the like. This self propelled roller wheel mode may be turned on based on a particular application that is run on the computer. The computer may be configured to send a control signal to the mouse to turn on the self propelled mode. Alternatively, the control device may detect that the user is rotating the roller wheel in a predetermined manner to turn on the self propelled mode. For example, the user may i) rotate the roller wheel for a period of time that is greater than a predetermined threshold period of time, ii) the roller wheel may be rotated above a fixed rate, or iii) the roller wheel may be rotated a repeated fixed number of times within a period of time. The self propelled mode may be turned off, for example, if the user touches the roller wheel, or may be turned off based on a received control command from the computer. For example, if the self propelled mode is turned on to scroll through a relatively long document (e.g., text document, code, diagram, etc.), at the end of the document, current to the coils may be turned off to turn of the self propelled mode.

According to another embodiment, one or both of the coils may be turned on to apply a braking action to the roller wheel. For example, if a document is being scrolled and the end of the document is reached, the coils may turn on to brake the roller wheel to indicate that the end of the document has been reached. It will be understood that braking may be used for a variety of applications.

According to one embodiment, the set of sensors 220 includes magnetic field sensors, such as Hall effect sensors, coils or the like. The sensors may be configured to detect the changing magnetic fields of magnets 230 as the roller wheel and magnets are rotated with respect to the sensor. The detected changing magnetic field of the rotating magnets may be detected by the sensors for encoding the roller wheel rotation. The sensors may also be configured to detect the magnetic fields of one or both of the coils.

According to another embodiment, current may be driven through one or both of the coils to effect a roller wheel “jog” mode. In the jog mode, the roller wheel may be rotated forward or back by increasing amounts to effect an increasing control signal generated by the control device. For example, the roller wheel may be rotated by a relatively small amount for relatively low speed scrolling or other function, and may be rotated by a relatively larger amount to for relatively higher speed scrolling. In the jog mode, the magnetic interaction between one or both of the coils and the fixed magnets may provide a return force to a “neutral” position. In the neutral position the control device may not provide scroll commands to the computer.

As will be understood by those as skilled in the art, the present invention may be embodied in other specific forms without departing from the essentially characteristics thereof. For example, the flywheel or magnetic rotor could be mounted inside the scroll wheel, rather than off to a side and connected by an axle. Metals other brass could be used for the flywheel, such as steel. Accordingly, the foregoing description is intended to be illustrative, but not limiting of the scope of the invention which is set forth in the following claims.

What is claimed is:

1. A user input device for interfacing with a host computer, comprising:
a rotatable wheel mounted in said input device, said wheel being rotatable by a finger of a user;
a wheel sensor mounted in said input device and providing a wheel signal to said host computer indicating a rotary position of said wheel;
a permanent magnet mounted in said device;
an electromagnet mounted adjacent said permanent magnet; and
a rotor made of a material which will magnetically interact with said permanent magnet and said electromagnet and coupled to said rotatable wheel and operative, in conjunction with at least one of said magnets, to provide a ratchet force to said rotatable wheel.

2. The device of claim 1 further comprising:
a control circuit configured to energize said electromagnet to provide a combined magnetic field from said permanent magnet and said electromagnet which is larger than a magnetic field from said permanent magnet alone.

3. The device of claim 1 further comprising:
a control circuit configured to energize said electromagnet to at least partially cancel a magnetic field from said permanent magnet alone.

4. The device of claim 1 further comprising an axle connecting said rotor to said wheel.

5. The device of claim 4 further comprising a planetary gear attached to and end of said axle, said planetary gear engaging a gear-toothed inside of said wheel.

6. The device of claim 1 further comprising a moveable member for adjusting a distance between said permanent magnet and said electromagnet.

7. The device of claim 6 wherein said moveable member is moveable via electric power.

8. The device of claim 1 further comprising a control circuit, responsive to a feedback signal from said host, for controlling an amount and direction of a magnetic field from said electromagnet to control and amount of ratcheting and a ratchet force.

9. user input device for interfacing with a host computer, comprising:
a rotatable wheel mounted in said input device, said wheel being rotatable by a finger of a user;
a wheel sensor mounted in said input device and providing a wheel signal to said host computer indicating a rotary position of said wheel;
a permanent magnet mounted in said device;
an electromagnet mounted adjacent said permanent magnet;
a rotor made of a material which will magnetically interact with said permanent magnet and said electromagnet and coupled to said rotatable wheel and operative, in conjunction with at least one of said magnets, to provide a ratchet force to said rotatable wheel;
an axle connecting said rotor to said wheel;
a planetary gear attached to and end of said axle, said planetary gear engaging a gear-toothed inside of said wheel; and
a control circuit configured to energize said electromagnet to provide a combined magnetic field from said permanent magnet and said electromagnet which is larger than a magnetic field from said permanent magnet alone;
wherein said control circuit is further configured to energize said electromagnet to at least partially cancel a magnetic field from said permanent magnet.

10. A user input device for interfacing with a host computer, comprising:
a rotatable wheel mounted in said input device, said wheel being rotatable by a finger of a user;
a wheel sensor mounted in said input device and providing a wheel signal to said host computer indicating a rotary position of said wheel;
a flywheel mounted in engagement with said rotatable wheel; and
a ratchet wheel mounted for intermittent engagement with said flywheel.

11. The device of claim 10 wherein said flywheel is metal with a rubber tire mounted on its circumference.

12. The device of claim 10 wherein said ratchet wheel is oval shaped such that it pushes against said flywheel with different forces as the oval rotates.

13. The device of claim 10 wherein said ratchet wheel is engageably biased against said flywheel.

14. The device of claim 13 further comprising a solenoid mounted to engage said ratchet wheel with said flywheel.

15. The device of claim 14 further comprising a control circuit for causing said solenoid to disengage said ratchet wheel from said flywheel in response to determined conditions to allow free rotation of said rotatable wheel without a ratchet effect.

16. The device of claim 10 further comprising a spring for biasing said ratchet wheel against said flywheel.

17. A user input device for interfacing with a host computer, comprising:
a rotatable wheel mounted in said input device, said wheel being rotatable by a finger of a user;
a wheel sensor mounted in said input device and providing a wheel signal to said host computer indicating a rotary position of said wheel;
a flywheel mounted in engagement with said rotatable wheel, wherein said flywheel is metal with a rubber tire mounted on its circumference;
a ratchet wheel mounted for intermittent engagement with said flywheel;
wherein said ratchet wheel is oval shaped such that it pushes against said flywheel with different forces as the oval rotates;
a spring for biasing said ratchet wheel against said flywheel; and
a solenoid mounted to engage said ratchet wheel with said flywheel.

18. A user input device for interfacing with a host computer, comprising:
a rotatable wheel mounted in said input device, said wheel being rotatable by a finger of a user;
a wheel sensor mounted in said input device and providing a wheel signal to said host computer indicating a rotary position of said wheel;
an electro-permanent magnet mounted in said device; and
a rotor made of a material which will magnetically interact with said electro-permanent magnet and coupled to said rotatable wheel and operative, in conjunction with said electro-permanent magnet, to provide a force to said rotatable wheel.

19. The device of claim 18 further comprising a controller coupled to said wheel sensor and said electro-permanent magnet, configured to pulse said electro-permanent magnet to modify its state to provide a ratchet force in response to the turning of said wheel.

20. A user input device for interfacing with a host computer, comprising:
a rotatable wheel mounted in said input device, said wheel being rotatable by a finger of a user;
a wheel sensor mounted in said input device and providing a wheel signal to said host computer indicating a rotary position of said wheel;
a permanent magnet mounted in said device;
a keeper mounted adjacent said permanent maget;
an actuator coupled to said keeper so that said keeper can be moved over said permanent magnet to constrain the flux from said permanent magnet, and can be removed from said permanent magnet to allow said flux to escape; and
a rotor made of a material which will magnetically interact with said permanent magnet and coupled to said rotatable wheel and operative, in conjunction with said magnets, to provide a force to said rotatable wheel.

21. The device of claim 20 further comprising a controller coupled to said wheel sensor and said actuator, configured to pulse said actuator to move said keeper to modify the flux from said permanent magnet to provide a ratchet force in response to the turning of said wheel.

22. A roller wheel for use in a user input device comprising
a roller wheel body;
at least a first coil rotationally coupled to the roller wheel body; and
a set of magnets coupled to the roller wheel body and configured to rotate with the roller wheel body, and rotate relative to the coil;
wherein current is configured to be driven through the coil to provide magnetic interaction between the coil and the magnet to provide a ratcheting force as the roller wheel body is rotated.

23. The roller wheel of claim 21, wherein if no current is driven through the coil than the roller wheel is configured to rotate in a smooth-roller mode.

24. The roller wheel of claim 21, The roller wheel of claim 21, further comprising a set of magnetic field sensors, wherein the magnets are configured to rotate relative to the magnetic field sensors and the magnetic field sensors are configured to detect the changing magnetic field from the rotating magnets for encoding rotation of the roller wheel body.

25. The roller wheel of claim 24, wherein the magnetic field sensors include Hall effect sensors.

26. The roller wheel of claim 21, further comprising a second coil, wherein the first mentioned coil and the second coil are configured to rotate the roller wheel body based on current driven alternately through the coils.
